(19) United States
(12) Patent Application Publication
(10) Pub. No.: US 2024/0317583 A1
(43) Pub. Date: Sep. 26, 2024

(54) NANO-SHEET FERRIC PHOSPHATE, PREPARATION METHOD THEREFOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Jinliang Duan, Foshan, Guangdong (CN); Changdong Li, Foshan, Guangdong (CN); Yang Xia, Foshan, Guangdong (CN); Dingshan Ruan, Foshan, Guangdong (CN); Ruokui Chen, Foshan, Guangdong (CN); Yanchao Qiao, Foshan, Guangdong (CN)

(21) Appl. No.: 18/580,637

(22) PCT Filed: Jun. 6, 2022
(86) PCT No.: PCT/CN2022/097182

§ 371 Date: Jan. 19, 2024

(30) Foreign Application Priority Data
Jul. 23, 2021 (CN) 202110834587.6

(51) Int. Cl. C01B 25/37; C01B 25/45; H01M 4/02; H01M 4/58

(52) U.S. Cl. CPC C01B 25/375; C01B 25/45; C01P 2002/72; C01P 2004/03; C01P 2004/20; C01P 2004/62; C01P 2006/10; C01P 2006/12; C01P 2006/40; H01M 2004/028; H01M 4/5825

(57) ABSTRACT

Disclosed in the present invention are nano-meter sheet ferric phosphate, a preparation method therefor and the use thereof. The preparation method includes the following steps: dissolving a phosphorus source and an iron source in an acidic solution, adding an oxidant, and mixing same to obtain a solution containing phosphorus and iron; adding a precipitation auxiliary agent into part of the solution containing phosphorus and iron, heating same until boiling, and then diluting same for a reaction to obtain a primary ferric phosphate slurry; and dropwise adding the remaining solution containing phosphorus and iron into the primary ferric phosphate slurry, and then heating same for a reaction to obtain ferric phosphate. In the present invention, a primary ferric phosphate is prepared by means of a dilution precipitation reaction, and the precipitation auxiliary agent is then added for two-step precipitation to regulate the growth of the ferric phosphate.

### TECHNICAL FIELD

The present disclosure belongs to the technical field of battery materials, and in particular relates to a nano-sheet ferric phosphate and a preparation method therefor and use thereof.

### BACKGROUND

Ferric phosphate is widely used in ceramics, pigments, additives, catalysts, foods and other industries as a good chemical product. In recent years, ferric phosphate has been used in the production of lithium iron phosphate cathode materials for lithium-ion batteries due to its unique chemical structure.

At present, one of the processes for synthesizing lithium iron phosphate is a ferric phosphate process, in which ferric phosphate is mainly used as a precursor, wet ground and mixed with a lithium source and a carbon source, and the lithium iron phosphate cathode material is prepared by a carbothermic reduction method. Ferric phosphate can provide an iron source and a phosphorus source at the same time, and only a lithium salt and a carbon source need to be added during the batching process. Therefore, the overall performance of the prepared lithium iron phosphate cathode material is largely determined by the chemical composition, structure, physicochemical properties, and reactivity of the ferric phosphate precursor. In addition, the ferric phosphate precursor accounts for a large proportion of the cost for producing the lithium iron phosphate cathode material. Because the ferric phosphate with high purity has a lower conductivity, it diffuses slowly during the charging and discharging process of the lithium battery, which will affect the performance of the lithium iron phosphate battery, so that it is necessary to modify the lithium iron phosphate. After research, it is found that nanocrystallizing ferric phosphate is beneficial to improving the electrochemical performance of materials. At present, hydrothermal method is the main preparation method for preparing nano-materials, which refers to a chemical reaction in which water is used as a solvent in a closed container under high pressure, high temperature and other conditions. However, the method has higher requirements for the equipment and has safety problems. Therefore, it is urgent to develop a method for preparing nano-scale ferric phosphate with low cost and simple and safe operation.

### SUMMARY

The present disclosure aims to solve at least one of the above-mentioned technical problems existing in the prior art. For this reason, the present disclosure provides a nano-sheet ferric phosphate and a preparation method therefor and use thereof. The method can regulate the morphology of ferric phosphate and increase a specific surface area and compaction density of ferric phosphate.

In order to achieve the above-described objectives, the present disclosure adopts the following technical solutions.

The present disclosure provides a method for preparing a nano-sheet ferric phosphate comprising the following steps:
(1) dissolving a phosphorus source and an iron source in an acidic solution, adding an oxidant and mixing to obtain a solution containing phosphorus and iron;
(2) heating part of the solution containing phosphorus and iron to boiling, adding a precipitation auxiliary agent, and performing dilution for a reaction to obtain a primary ferric phosphate slurry; and
(3) adding the remaining solution containing phosphorus and iron dropwise into the primary ferric phosphate slurry, and performing heating for a reaction to obtain ferric phosphate.

The precipitation auxiliary agent is added after boiling, then water is added to dilute the reaction system for the reaction, and nucleation is stimulated by drastic changes in the reaction conditions (temperature, free acid) during the addition of water.

Preferably, in step (3), filtering, washing, and drying the ferric phosphate is further included.

Preferably, in step (1), the iron source is at least one of elementary iron, ferric salt, ferrous salt, magnetite, or hematite.

More preferably, in the case where the iron source is elementary iron and/or ferrous salt, an oxidant is also added to the solution containing phosphorus and iron.

More preferably, the oxidant is hydrogen peroxide.

More preferably, the elementary iron is iron powder.

More preferably, the ferric salt is at least one of ferric phosphate, ferric sulfate, ferric nitrate, or ferric chloride.

More preferably, the ferrous salt is at least one of ferrous sulfate, ferrous chloride, or ferrous nitrate.

Preferably, in step (1), the phosphorus source is at least one of phosphoric acid, dihydrogen phosphate, hydrogen phosphate, hydroxyethylidene diphosphonate, or amino trimethylene phosphate.

Preferably, in step (1), the acidic solution is at least one of sulfuric acid, hydrochloric acid, and nitric acid.

Preferably, in step (1), the acidic solution has a concentration of 1 mol/L to 18 mol/L.

More preferably, in step (1), the acidic solution has a concentration of 2 mol/L to 10 mol/L.

Preferably, in step (1), the solution containing phosphorus and iron has an iron element concentration of 20 g/L to 75 g/L, more preferably 30 g/L to 65 g/L.

Preferably, in step (1), the solution containing phosphorus and iron has a phosphorus element concentration of 11 g/L to 42 g/L, more preferably 17 g/L to 36 g/L.

Preferably, in step (1), the solution containing phosphorus and iron has an iron-phosphorus ratio (molar ratio) of 1:(0.95-1.05).

Preferably, in step (2), water is added for dilution during the dilution for the reaction, wherein a volume ratio of the added water to the part of the solution containing phosphorus and iron is (2-20):1, and more preferably (3-10):1.

The amount of water added for the dilution for the reaction is very important for this reaction. If the amount of the added water is too small, there will be too much free acid during the dilution, and the concentrations of the iron and phosphorus will be too high, which is not conducive to the formation of crystal nucleus. When the amount of the added water is too much, the concentrations of the iron and phosphorus in the solution containing phosphorus and iron will be too low to form crystal nucleus.

Preferably, in step (2), the precipitation auxiliary agent is at least one of titanium chloride, titanium sulfate, titanium dioxide, aluminum chloride, aluminum sulfate, or ferric phosphate.

Preferably, in step (2), an addition amount of the precipitation auxiliary agent is 0.1% to 50%, and more preferably 1% to 20% of the total amount of iron and phosphorus in the part of the solution containing phosphorus and iron. Adding the precipitation auxiliary agent before dilution can not only promote the precipitation reaction, but also regulate the growth of the product and control the morphology.

Preferably, in step (2), the dilution for the reaction comprises adding water for dilution and aging; and the dilution for the reaction is divided into two steps. The first step is continuous addition of water, and the time for adding water is 5 min to 120 min; and the second step is standing for aging, and the aging time is 5 min to 240 min, more preferably 10 min to 180 min.

The crystal nucleus is formed during the dilution for the reaction, and the crystal nucleus gradually accumulates and grows by aging, making it more stable.

Preferably, in step (3), before adding the remaining solution containing phosphorus and iron into the primary ferric phosphate slurry, adding the precipitation auxiliary agent into the remaining solution containing phosphorus and iron is further included. The addition amount of the precipitation auxiliary agent is 0.05% to 25%, and more preferably 0.2% to 10% of the total amount of iron and phosphorus in the remaining solution containing phosphorus and iron.

Preferably, in step (3), the time for adding the remaining solution containing phosphorus and iron into the primary ferric phosphate slurry is 10 min to 120 min.

Preferably, in step (3), a temperature for the heating for the reaction is 30° C. to 95° C., and the reaction time is 30 min to 360 min; more preferably, the reaction temperature is 40° C. to 95° C. The reaction temperature has a greater influence on ferric phosphate. As the temperature increases, more non-activated molecules will become activated molecules. The more activated molecules are, the more effective collisions are and the faster the reaction rate is. However, when the temperature is too high, the evaporation amount of the solution will increase, making the acidity of the system increase, which is not conducive to the growth of ferric phosphate.

A nano-sheet ferric phosphate is prepared by the aforementioned method. The nano-sheet ferric phosphate has a particle size D50 of 200 nm to 300 nm, a specific surface area of 40 m²/g to 43 m²/g, and a compaction density of 2.4 g/cm³ to 2.8 g/cm³.

A lithium iron phosphate is prepared from the nano-sheet ferric phosphate.

Compared with the prior art, the present disclosure has beneficial effects as follows.
1. In the present disclosure, the phosphorus source and the iron source are used as raw materials, the primary ferric phosphate is prepared by the dilution for a precipitation reaction, then the precipitation auxiliary agent is added for two-step precipitation to regulate the growth of ferric phosphate, thereby controlling the morphology of ferric phosphate. The added precipitation auxiliary agent can not only regulate the morphology, but also act as a dopant, which increases the specific surface area and compaction density of ferric phosphate. The preparation process requires no high temperature, high pressure, and other harsh conditions, and is safe and simple, and no other impurities are introduced during the reaction, which is environmentally friendly and low in cost.
2. The nano-sheet ferric phosphate prepared by the method of the present disclosure has a D50 of 200 nm to 300 nm, a specific surface area of 40 m²/g to 43 m²/g, and a compaction density of 2.4 g/cm³ to 2.8 g/cm³.

### BRIEF DESCRIPTION OF DRAWINGS

The present disclosure will be further described below with reference to the accompanying drawings and examples, in which:

FIG. 1 shows a scanning electron microscope (SEM) image of a ferric phosphate product of Example 1 of the present disclosure; and

FIG. 2 shows an X-Ray Diffraction (XRD) pattern of the ferric phosphate product of Example 1 of the present disclosure.

### DETAILED DESCRIPTION OF EMBODIMENTS

The concept and the technical effects of the present disclosure will be described clearly and completely hereinafter with reference to the examples for a thorough understanding of the purposes, features and effects of the present disclosure. It is apparent that the described examples are only a part of the examples of the present disclosure, and not all of the examples, and other examples obtained by those skilled in the art based on the examples of the present disclosure without creative efforts fall within the protection scope of the present disclosure.

### Example 1

A method for preparing a nano-sheet ferric phosphate provided by this example included the following steps.
(1) Sodium phosphate and iron nitrate were dissolved in 2 mol/L of sulfuric acid solution to obtain a solution containing phosphorus and iron with an iron concentration of 45 g/L and a phosphorus concentration of 25 g/L. The solution containing phosphorus and iron was divided into two parts A and B (with a volume ratio of 1:1) for use.
(2) The solution containing phosphorus and iron A was heated to boiling, and after adding titanium sulfate with an amount of 5% of the total amount of phosphorus and iron in the solution containing phosphorus and iron A, the reaction system was diluted for a reaction by adding water, wherein water was added for 30 minutes. After adding water, the reaction system was allowed to stand for aging for 120 minutes, and then a primary ferric phosphate slurry was obtained.
(3) 2% of titanium sulfate was added to the solution containing phosphorus and iron B, then the solution containing phosphorus and iron B was added to the primary ferric phosphate slurry for 60 minutes, and then heated and stirred and reacted at 80° C. for 120 minutes to obtain ferric phosphate.
(4) The obtained ferric phosphate was filtered, washed, and dried to obtain a ferric phosphate product.

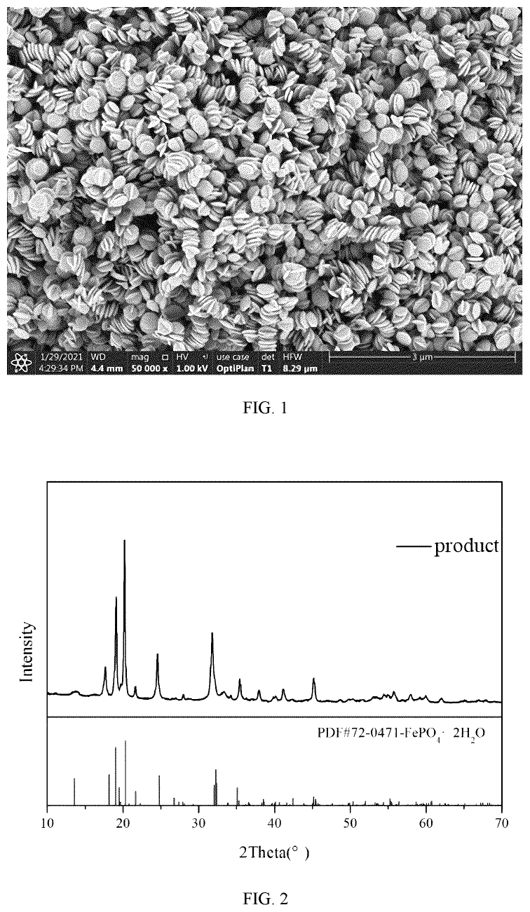

FIG. 1 showed an SEM image of the ferric phosphate product of Example 1 of the present disclosure. It could be seen from FIG. 1 that the ferric phosphate particles prepared in Example 1 were uniformly distributed and had a sheet-like structure with a particle size of about 250 nm without agglomeration.

FIG. 2 showed an XRD pattern of the ferric phosphate product of Example 1 of the present disclosure. It could be seen from FIG. 2 that the XRD pattern of the prepared ferric phosphate exhibits characteristic peaks corresponding to the standard card (72-0471) pattern, its diffraction peaks were sharp, the characteristic peaks were obvious, and there were no unnecessary impurity peaks, indicating that ferric phosphate with high crystallinity was obtained.

### Example 2

A method for preparing a nano-sheet ferric phosphate provided by this example included the following steps.
(1) Sodium hydrogen phosphate and iron sulfate were dissolved in 3 mol/L of sulfuric acid solution to obtain a solution containing phosphorus and iron with an iron concentration of 53 g/L and a phosphorus concentration of 29 g/L. The solution containing phosphorus and iron was divided into two parts A and B (with a volume ratio of 1:1) for use.
(2) The solution containing phosphorus and iron A was heated to boiling, and after adding aluminum sulfate with an amount of 6% of the total amount of phosphorus and iron, water was continuously added for 50 minutes by 6 times the volume of the solution containing phosphorus and iron. After adding water, the reaction system was allowed to stand for aging for 150 minutes, and a primary ferric phosphate slurry was obtained.
(3) 2% of aluminum sulfate was added to the solution containing phosphorus and iron B, then the solution containing phosphorus and iron B was continuously added to the primary ferric phosphate slurry for 40 minutes, and then heated and stirred and reacted at 90° C. for 90 minutes to obtain ferric phosphate.
(4) The obtained ferric phosphate was filtered, washed, and dried to obtain a ferric phosphate product.

### Example 3

A method for preparing a nano-sheet ferric phosphate provided by this example included the following steps.
(1) Potassium phosphate and iron chloride were dissolved in 2 mol/L of sulfuric acid solution to obtain a solution containing phosphorus and iron with an iron concentration of 49 g/L and a phosphorus concentration of 26 g/L. The solution containing phosphorus and iron was divided into two parts A and B (with a volume ratio of 1:1) for use.
(2) The solution containing phosphorus and iron A was heated to boiling, and after adding titanium chloride with an amount of 3% of the total amount of phosphorus and iron, water was continuously added for 40 minutes by 5 times the volume of the solution containing phosphorus and iron. After adding water, the reaction system was allowed to stand for aging for 120 minutes, and a primary ferric phosphate slurry was obtained.
(3) 3% of titanium chloride was added to the solution containing phosphorus and iron B, then the solution containing phosphorus and iron B was continuously added to the primary ferric phosphate slurry for 50 minutes, and then heated and stirred and reacted at 85° C. for 100 minutes to obtain ferric phosphate.
(4) The obtained ferric phosphate was filtered, washed, and dried to obtain a ferric phosphate product.

### Comparative Example 1

A method for preparing a nano-sheet ferric phosphate provided by this comparative example included the following steps.
(1) Sodium phosphate and ferrous sulfate were dissolved in 2 mol/L of sulfuric acid, respectively, to obtain an acidic iron solution and an acidic phosphorus solution, which were prepared into an acidic solution containing phosphorus and iron at a ratio of iron to phosphorus of 1:1.03.
(2) Oxygen was introduced into the acidic solution containing phosphorus and iron to oxidize for 2 hours until Fe²⁺ in the solution had been oxidized to Fe³⁺, then aqueous ammonia was added to adjust the pH to 3, the mixture was reacted at 90° C. for 3 hours, and then ferric phosphate was obtained by liquid-solid separation.
(3) The obtained ferric phosphate was washed, filtered, and dried to obtain a ferric phosphate product.

### Comparative Example 2

A method for preparing a nano-sheet ferric phosphate provided by this comparative example included the following steps.
(1) Preparation of iron raw material liquid: according to molar ratios of Fe₂(SO₄)₃:(H₂SO₄+H₃PO₄)=1:0.2 and H₂SO₄:H₃PO₄=9:1, iron sulfate solution, sulfuric acid solution, and phosphoric acid solution were mixed to obtain an iron sulfate raw material liquid, wherein the iron sulfate raw material liquid had a pH of 1.03, and a mass concentration of iron element in the iron sulfate raw material liquid was 84 g/L.
(2) Preparation of phosphate raw material liquid: ammonium phosphate was dissolved in water to obtain a phosphate raw material liquid. A mass concentration of phosphorus element in the phosphate raw material liquid was 45 g/L.
(3) Proceeding of the synthesis reaction: the phosphate raw material liquid obtained in step (2) was gradually added into the iron sulfate raw material liquid obtained in step (1) under stirring, according to a ratio that a molar ratio of iron in the iron sulfate raw material liquid to phosphorus in the phosphate solution was 1:1, to obtain a mixed solution. Then, the mixed solution was heated to 90° C. and reacted for 3 hours to obtain a ferric phosphate slurry.
(4) The obtained ferric phosphate was washed, filtered, and dried to obtain a ferric phosphate product.

### Comparative Example 3

A method for preparing a nano-sheet ferric phosphate provided by this comparative example included the following steps.
(1) An aqueous solution containing 0.05 mol/L of iron nitrate and 0.05 mol/L of phosphoric acid was prepared to obtain a raw material A.
(2) 0.1 mol/L of ammonium phosphate aqueous solution was prepared to obtain a raw material B, and 1 L of the raw material A and 1 L of the raw material B were quickly mixed by using a membrane dispersion micro-mixer to obtain a slurry C.
(3) The slurry C was subjected to hydrothermal treatment under atmospheric pressure for 0.2 hour at a treatment temperature of 100° C., then a precipitate was filtered out from the slurry C, and then the precipitate was washed and dried to obtain a ferric phosphate product.

### Comparative Example 4

Comparing this comparative example with Example 1: no precipitation auxiliary agent was added in step (2).

### Comparative Example 5

Comparing this comparative example with Example 1: the reaction system was not diluted for a reaction by water in step (2).

TABLE 1
Comparison of specific test data of the ferric phosphate
prepared in Examples 1-3 and the ferric phosphate
prepared in Comparative Examples

| | Particle size | Compaction density | Specific surface |
|---|---|---|---|
| | D50 (nm) | (g/cm³) | area (m²/g) |
| Example 1 | 249 | 2.57 | 41.32 |
| Example 2 | 260 | 2.41 | 40.20 |
| Example 3 | 255 | 2.47 | 40.63 |
| Comparative | 3200 | 2.19 | 22.96 |
| Example 1 | | | |
| Comparative | 5300 | 1.96 | 17.63 |
| Example 2 | | | |
| Comparative | 3700 | 2.11 | 20.42 |
| Example 3 | | | |
| Comparative | 2980 | 1.97 | 24.3 |
| Example 4 | | | |
| Comparative | 2200 | 2.15 | 30.65 |
| Example 5 | | | |

It can be seen from the data in Table 1 that the ferric phosphate prepared in Examples of the present disclosure was nano-scale ferric phosphate, while the ferric phosphate prepared in Comparative Examples was micro-scale ferric phosphate. The data comparation showed that the prepared nano-scale ferric phosphate can significantly improve the specific surface area and compaction density of ferric phosphate.

The embodiments of the present disclosure are described in detail above, but the present disclosure is not limited to the above-mentioned embodiments, and various changes can be made without departing from the purpose of the present disclosure within the scope of knowledge possessed by those of ordinary skill in the art. In addition, embodiments in the present disclosure and features in the embodiments can be combined with each other under the premise of no conflict.

1. A method for preparing a nano-sheet ferric phosphate, comprising the following steps:
(1) dissolving a phosphorus source and an iron source in an acidic solution to obtain a solution containing phosphorus and iron;
(2) heating part of the solution containing phosphorus and iron to boiling, adding a precipitation auxiliary agent, and performing dilution for a reaction to obtain a primary ferric phosphate slurry; and
(3) adding the remaining solution containing phosphorus and iron dropwise into the primary ferric phosphate slurry, and performing heating for a reaction to obtain ferric phosphate.

2. The method according to claim 1, wherein step (3) further comprises filtering, washing, and drying the ferric phosphate.

3. The method according to claim 1, wherein in step (1), the iron source is at least one of elementary iron, ferric salt, ferrous salt, magnetite, or hematite; preferably, in a case where the iron source is elementary iron and/or ferrous salt, an oxidant is further added to the solution containing phosphorus and iron.

4. The method according to claim 1, wherein in step (1), the phosphorus source is at least one of phosphoric acid, dihydrogen phosphate, hydrogen phosphate, hydroxyethylidene diphosphonate, or amino trimethylene phosphate.

5. The method according to claim 1, wherein in step (2), the acidic solution is at least one of sulfuric acid, hydrochloric acid, and nitric acid.

6. The method according to claim 1, wherein in step (2), water is added for dilution during the dilution for the reaction, wherein a volume ratio of the added water to the part of the solution containing phosphorus and iron is (2-20):1; preferably, in step (2), the dilution for the reaction comprises diluting by adding water and aging.

7. The method according to claim 1, wherein in step (2), the precipitation auxiliary agent is at least one of titanium chloride, titanium sulfate, titanium dioxide, aluminum chloride, aluminum sulfate, or ferric phosphate.

8. The method according to claim 1, wherein step (3) further comprises adding the precipitation auxiliary agent into the remaining solution containing phosphorus and iron before adding the remaining solution containing phosphorus and iron into the primary ferric phosphate slurry.

9. A nano-sheet ferric phosphate, which is prepared by the method according to claim 1, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

10. A lithium iron phosphate, which is prepared from the nano-sheet ferric phosphate according to claim 9.

11. A nano-sheet ferric phosphate, which is prepared by the method according to claim 2, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

12. A nano-sheet ferric phosphate, which is prepared by the method according to claim 3, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

13. A nano-sheet ferric phosphate, which is prepared by the method according to claim 4, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

14. A nano-sheet ferric phosphate, which is prepared by the method according to claim 5, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

15. A nano-sheet ferric phosphate, which is prepared by the method according to claim 6, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

16. A nano-sheet ferric phosphate, which is prepared by the method according to claim 7, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.

17. A nano-sheet ferric phosphate, which is prepared by the method according to claim 8, wherein the nano-sheet ferric phosphate has a sheet diameter D50 of 200 nm to 300 nm, a specific surface area of 40 m²/g to 43 m²/g, and a compaction density of 2.4 g/cm³ to 2.8 g/cm³.
